(19) United States
(12) Patent Application Publication
(10) Pub. No.: US 2007/0273262 A1
(43) Pub. Date: Nov. 29, 2007

(54) Light Source with Electron Cyclotron Resonance

(76) Inventors: Pascal Sortais, Meylan (FR); Xavier Pellet, Meylan (FR)

Correspondence Address: OLIFF & BERRIDGE, PLC, P.O. BOX 19928, ALEXANDRIA, VA, 22320, US

(21) Appl. No.: 10/594,901

(22) PCT Filed: Apr. 28, 2005
(86) PCT No.: PCT/FR05/01063

§ 371 Date: Sep. 29, 2006

(30) Foreign Application Priority Data
Apr. 29, 2004 (FR) 04 04551

(51) Int. Cl. H05H 13/00

(52) U.S. Cl. 313/62

(57) ABSTRACT

The light source comprises an emitter (4) which, by means of at least one antenna (3), creates an ultra high-frequency electromagnetic wave in a sealed chamber (1) and which provides the lamp with power. The chamber (1) has a wall that is transparent to light and contains a gas at low pressure. A permanent magnet (2) creates a static magnetic field inside the chamber (1). The respective values of the static magnetic field and of the frequency of the electromagnetic wave are determined such as to cause an electron cyclotron resonance inside the chamber (1). The emitter (4), antenna (3) and magnet (2) are disposed in relation to the chamber (1) in such a way as to free a solid angle of at least 2π steradians for the light. The antenna (3) can be disposed inside the chamber (1) and can, optionally, be formed by the magnet (2). The magnet is substantially enveloped by the chamber (1).

### BACKGROUND OF THE INVENTION

The invention relates to a light source supplied by ultra-high frequency, comprising an emitter which, by means of at least one antenna, creates an ultra high-frequency electromagnetic wave in a sealed chamber having a wall transparent to light and containing a gas at low pressure, the source comprising magnetic means designed to create a static magnetic field inside the chamber, the respective values of the static magnetic field and of the frequency of the electromagnetic wave being predetermined in such a way as to cause an electron cyclotron resonance inside the chamber.

### STATE OF THE ART

Visible or ultraviolet (UV) light sources supplied by ultra-high frequency conventionally comprise an emitter creating an ultra high-frequency electromagnetic wave in a sealed chamber that is transparent to light and contains a gas at low pressure. The gas can be ionized and the electrons accelerated by means of an ultra high-frequency discharge. The energetic electrons ionize the gas so as to create a stationary plasma. When collisions occur between the electrons and the ions, a light radiation is emitted.

The document GB2375603 describes a UV light source comprising control means enabling the intensity of the emitted UV radiation to be optimized, in particular in the UVC band of the ultraviolet spectrum.

The document U.S. Pat. No. 6,657,206 describes a system for generating UV radiation comprising a microwave chamber wherein a plasma lamp is located. A microwave generator is coupled to the microwave chamber to excite the plasma in the plasma lamp, the latter thus emitting a UV radiation.

UV light is used for example for characterization, imagery, photolithography, disinfection or for ozone production. In most applications, a strong luminance is required. However known sources often have a low light efficacy and/or present high costs due to a limited lifetime.

Moreover, conventional gas discharged-based light sources comprise electrodes in contact with the plasma. The wear of the electrodes, due to bombardment by the ions of the plasma, limits the lifetime of the light sources.

The document GB1020224, for example, describes an ultraviolet lamp with electron cyclotron resonance designed to create a particular plasma at high temperature and a distant ultraviolet radiation. The plasma is created in a discharge tube containing a gas at low pressure. Two electrodes are arranged inside the tube to create the plasma by means of a low-frequency subsidiary discharge. Two coils surround the external periphery of the discharge tube and create an axial magnetic field limiting the plasma essentially to the central axis of the tube. The tube passes through the side walls of a waveguide coupled with a high-frequency source so as to project an electromagnetic radiation into the plasma, perpendicularly to the magnetic field. A beam of parallel ultraviolet rays is emitted through an opening arranged in the center of one of the electrodes. This lamp is difficult to implement.

The document U.S. Pat. No. 3,911,318 describes a method and an apparatus for generating a high-power electromagnetic radiation that is UV and visible. The apparatus is supplied by a radiofrequency generator creating a radiofrequency field inside a plasma tube made of quartz or of molten silica enabling the UV radiation to escape. The gas pressure in the tube is sufficient to sustain generation of a plasma by microwave. The apparatus comprises Helmholz coils creating a static magnetic field inside the tube. A meshed shield acting as waveguide enables the radiofrequency radiation to be confined. The apparatus only enables illumination in a limited solid angle. In addition, the apparatus is bulky.

### OBJECT OF THE INVENTION

The object of the invention is to remedy these shortcomings and, in particular to provide an electrode-free light source, and in particular a compact UV source supplying a strong light intensity and presenting a high efficacy.

According to the invention, this object is achieved by the appended claims and, in particular, by the fact that the magnetic means are formed by at least one permanent magnet substantially enveloped by the chamber and by the fact that the emitter, the antenna and the magnet are disposed with respect to the chamber in such a way as to free a solid angle of at least 2π steradians for the light.

### BRIEF DESCRIPTION OF THE DRAWINGS

Other advantages and features will become more clearly apparent from the following description of particular embodiments of the invention given as non-restrictive examples only and represented in the accompanying drawings, in which:

FIGS. 1 to 5 represent, in cross-section, five particular embodiments of a light source according to the invention.

FIG. 6 represents, versus time, three particular embodiments of the radiofrequency power supplying the light source according to the invention.

### DESCRIPTION OF PARTICULAR EMBODIMENTS

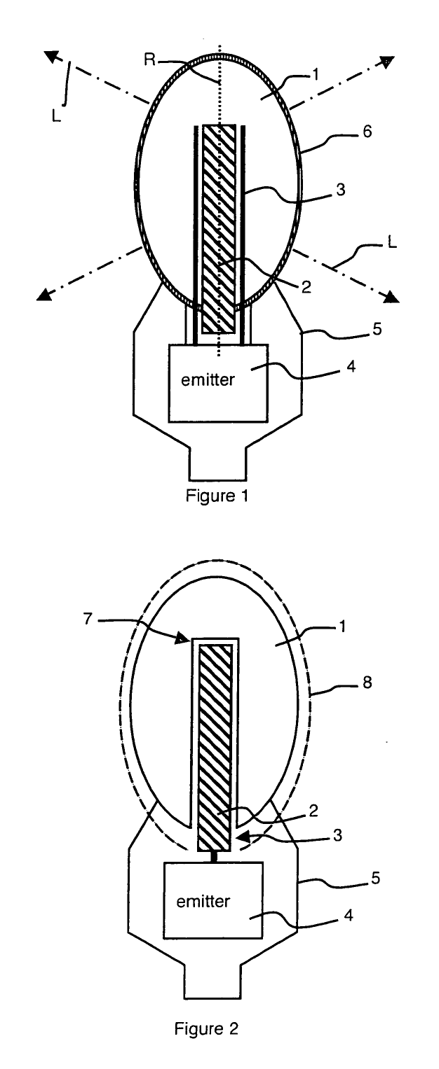

The light source represented in FIG. 1 comprises a sealed chamber 1 substantially in the form of a bulb, having an external wall transparent to light. The chamber 1 contains a gas at low pressure, for example one or more rare gases at a total pressure of 2 μbar, deuterium or a metal vapor, for example sodium, zinc or mercury. When the gas is a mercury vapor, the pressure in the chamber 1 can be the pressure of mercury vapor at room temperature which is about 2 μbar. The wall of the chamber 1 can be transparent only in a required spectral band, for example in a visible band or in a UV band. Typically, the materials used for the light sources have a cut-off wavelength situated in the UV band of the electromagnetic spectrum, for example at 150 nm.

In FIG. 1, a single permanent magnet 2 and an antenna 3 connected to an emitter 4 penetrate into the chamber 1 in hermetically sealed manner. The permanent magnet 2 and the antenna 3 are then arranged partly inside the chamber 1 and partly outside the chamber 1. The parts arranged outside the chamber 1 are disposed in an enclosure 5 that also houses the emitter 4. The latter can be for example a magnetron or a transistor-based emitter of the same type as those used in portable telephones, able to operate at low voltage, for example at 3V. The emitter has a power for example comprised between 1 Watt and 300 W, depending on the type of emitter.

The magnet 2 creates a static magnetic field inside the chamber 1. The emitter 4 enables the light source to be supplied by an ultra high-frequency electromagnetic wave created in the chamber 1. The ultra high-frequency electromagnetic wave enables the gas to be ionized and the electrons to be accelerated. The frequency of the ultra high-frequency electromagnetic wave is comprised between 300 MHz and 300 GHz.

In the static magnetic field, the electrons are subjected to a force perpendicular to their velocity. The paths of the electrons are then circular or in the form of spirals that are characterized, in known manner, by a gyromagnetic radius that is inversely proportional to the magnetic field, and by a cyclotron frequency that is proportional to the magnetic field. The electrons are then confined by the static magnetic field.

The gyromagnetic radius and cyclotron frequency are, in principle, defined only in a uniform field, whereas the magnetic field created by a magnet 2 having dimensions that are about the same as those of the chamber 1 in fact presents a gradient in the chamber 1. However, the gyromagnetic radius and cyclotron frequency enable certain orders of magnitude to be estimated, in particular the respective values of the static magnetic field and of the frequency of the electromagnetic wave. These values are predetermined in such a way as to cause an electron cyclotron resonance inside the chamber, at least in a resonance zone located in the chamber.

The magnetic field must be strong enough for the gyromagnetic radius to be smaller than the dimension of the chamber 1. A magnetic field of about 0.1 Tesla, for example, enables the electrons to be confined in a chamber 1 having dimensions of a few decimeters, which corresponds to the typical dimension of a light source. The cyclotron frequency in a 0.1 Tesla field is about 2 GHz.

When the frequency of the ultra high-frequency electromagnetic wave corresponds to the cyclotron frequency, a resonance effect is obtained. The resonance relation between the static magnetic field B and the frequency f of the ultra high-frequency electromagnetic wave, B=f.2.π.m/e, depends solely on the ratio of the mass m and charge e of the electron. When the static magnetic field is 0.1 Tesla, the frequency of the ultra high-frequency electromagnetic wave is then about 2 GHz. An electron cyclotron resonance is then obtained inside the chamber. The static magnetic field is preferably 0.0875 Tesla and the frequency of the ultra high-frequency electromagnetic wave is 2.45 GHz, which is a frequency usually used in ultra high-frequency sources. As the static magnetic field presents a gradient, the resonance conditions are not necessarily fulfilled in the whole of the space of the chamber. The maximum resonance zone can be of any shape, defined by the distributions of the static magnetic field and of the ultra high-frequency electromagnetic wave. The shape of the chamber is preferably chosen such as to suit the distribution of the field of the magnet 2 used and the antenna 3 is arranged in such a way that the whole space delineated by the chamber 1 receives the ultra high-frequency electromagnetic wave.

It should be noted that the electrons can in theory gain or lose energy due to the effect of the electromagnetic wave, depending on the direction of their velocity with respect to the electric field of the wave. In addition, the electrons undergo collisions with the ions of the plasma in the resonance zone. However, as the electrons are confined by the static magnetic field, it happens that after a large number of passages through the zone subjected to the electromagnetic wave, the energy balance of the electrons is positive and can be comprised between 1 electronvolt and several tens of electronvolts per electron, for example 50 eV. This balance determines the power supply of the light source. The energy is then emitted in the course of radiative inelastic collisions with the ions, in the visible spectrum and in particular in the UV spectrum.

The luminous efficacy of the light source, more than 100 lumens per Watt, is considerably higher than that of known light sources, enabling a predetermined luminosity to be obtained at very low supply power.

In a starting phase of the light source, the accelerated electrons ionize the gas to a greater extent so as to increase the electron density. However, in known manner, a plasma acts as a screen for the frequencies lower than the cut-off frequency of the plasma, which depends on the square root of the electron density in the plasma. As the density increases in the course of the starting phase, the cut-off frequency increases in corresponding manner until the cut-off frequency reaches the value of the frequency of the injected ultra high-frequency electromagnetic wave. The plasma then reaches a saturation electron density, typically after a few tens of microseconds. The minimum pressure required for starting is about 0.4 μbar.

In the light source represented in FIG. 1, the emitter 4, the antenna 3 and the magnet 2 are disposed, with respect to the chamber 1, in such a way as to release a large solid illumination angle, larger than 2π steradians, for the light. Indeed, in FIG. 1, the light L is emitted all around an axis of rotation R. Only the enclosure 5 limits the solid illumination angle of the light source. A large illumination field is then obtained. This light source presents the advantage of being able to operate at low temperature, for example at room temperature. However, a maximum intensity is obtained at a higher temperature, for example about 40° C.

In FIG. 1, the chamber 1 substantially envelops the magnet 2 and the antenna 3 which enables the gas located in the chamber to absorb the electromagnetic radiation emitted by the antenna 3 very efficiently. Moreover, the resonance zone arranged in the chamber 1 automatically forms a radiation shield enabling the ultra high-frequency electromagnetic radiation outside the light source to be limited.

The light source supplies a radiation in the visible spectrum and in the UV spectrum, corresponding to emission lines of the gas atoms and ions. The 254 nm line of the non-ionized mercury atom can reach a luminance ten times greater than a standard UV lamp. The ion emission lines having wavelengths of less than 200 nm are particularly intense. The lines of mercury atoms ionized once, having wavelengths of 164.9 nm and 194.2 nm, are about five times more intense than the 254 nm line of the non-ionized mercury atom. The choice of gas and pressure in the chamber enables the source spectrum to be adapted to suit its use, in particular to suit the required UV regime. For example, the higher the pressure, the more the lines emitted at long wavelengths, i.e. the non-ionized atom emission lines, dominate. Knowing the atomic spectra of the atoms constituting the gas and the ion spectra of the atoms ionized once or several times thus enables the required radiation to be obtained. The radiation created is characterized by the corresponding atomic and ionic lines.

To constitute a visible light source, the chamber 1 can comprise, as represented in FIG. 1, a fluorescent coating 6 transforming an ultraviolet radiation into visible radiation.

In the light source represented in FIG. 2, the magnet 2 at the same time constitutes the antenna 3 of the emitter 4. The chamber 1 comprises an external housing 7 for the magnet 2. Thus, the magnet 2 is located entirely outside the chamber 1 and is not subjected to the action of the plasma when the light source is operating. As the chamber 1 substantially envelops the magnet 2 forming the antenna 3, the light is always emitted in a large solid angle. The light source represented in FIG. 2 comprises a fine protective meshing 8 against ultra high-frequency radiation enabling safety standards to be complied with even in the case of operation of the emitter 4 at high power. Such a meshing 8 can also be provided in the embodiment of FIG. 1 and in the other embodiments described below. The fine meshing 8 can be arranged outside the chamber 1, as represented in FIG. 2, or inside the chamber 1, so as to envelop the resonance zone in which the antenna 3 is arranged.

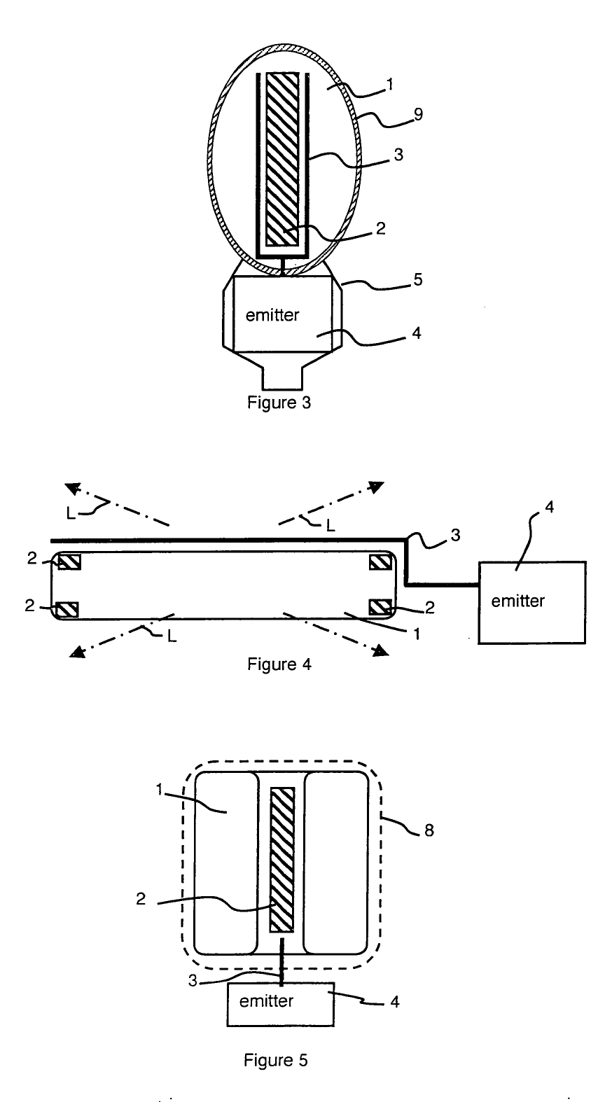

In the particular embodiment represented in FIG. 3, the magnet 2 and the antenna 3 of the emitter 4 are arranged entirely inside the chamber 1. Thus, the magnet 2 and the antenna 3 are completely surrounded by the gas and do not imitate the solid angle in which the source radiates. Only the enclosure 5 limits the illumination field. In FIG. 3, the chamber 1 comprises a transparent conducting coating 9 on an internal face or an external face of the wall of the chamber 1, surrounding the antenna 3 and thus forming a protective shield against ultra high-frequency radiation.

In the particular embodiment represented in FIG. 4, the chamber 1 has a tubular shape and four magnets 2 are arranged at the ends of the tubular chamber 1, inside the chamber 1 and on each side of the central axis of the chamber, so as to create a magnetic trap for the electrons and ions of the plasma. At least two magnets 2 are necessary to form such a trap. In the particular embodiment represented, the antenna 3 is arranged along the chamber 1, on one side thereof. The tubular chamber 1 enables light to be obtained in a large solid angle, at least equal to 2π steradians.

The light source according to the invention can have any dimensions and more particularly be of very small dimensions if the wavelength of the injected electromagnetic wave and the static magnetic field are adapted to the dimensions of the source. Thus, the source represented in FIGS. 1 to 3, for example, can have dimensions of about one centimeter, the frequency of the electromagnetic wave being about 30 GHz and the static magnetic field being about 1 Tesla. The ultra high-frequency emitter 4 can for example comprise a microelectronic circuit providing a power less than or equal to 1 Watt. A plurality of light sources can for example be grouped together in the form of a network.

The lifetime of the source is limited by the lifetime of the emitter 4 which is typically considerably greater than the lifetime of a conventional light source, for example that of an incandescent or fluorescent bulb. The coupling efficiency of the ultra high-frequency electromagnetic wave and of the plasma is very high on account of the electron cyclotron resonance. The luminous efficacy of the source is therefore very good. The energy of the ultra high-frequency electromagnetic wave is essentially transferred to the electrons, and not to the ions, and is therefore directly useful for radiative and ionizing collisions without heating the plasma, which enables the light source to be used at low consumption.

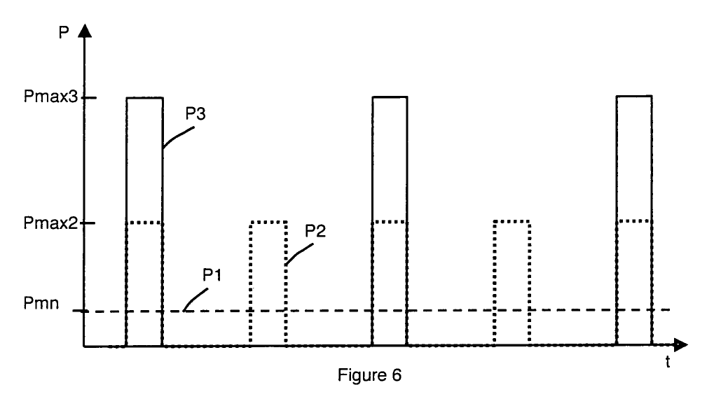

It is also possible to perform modulation of the power P of the radiofrequency wave input to the chamber 1, for example in the form of pulses of any shape and frequency. These pulses are preferably rectangular, as represented in FIG. 6. The three curves P1, P2 and P3 correspond to the same mean power Pmn and therefore correspond to the same mean light intensity. Indeed, according to the curve P1 a predetermined continuous power is input to the chamber 1. The continuous power (P1) is equal to the mean power Pmn. The mean power Pmn injected is preferably comprised between 10 and 1000 W. The curve P2 represents rectangular pulses having a maximum power Pmax2, for example with a frequency of 50 Hz, and having a duty cycle such that the mean power Pmn input to the chamber 1 is the same as that of the curve P1. The curve P3 presents a frequency that is half as high as that of the curve P2 (in the 50 Hz example) and a maximum power Pmax3 of the rectangular pulses that is twice as great as that of the curve P2. The mean power Pmn of the curves P2 and P3 is therefore effectively equal. However, since the maximum powers of the curves P1, P2 and P3 are different, the curves P1, P2 and P3 correspond to different light spectra.

The sequence of rectangular pulses is not necessarily periodic. It can in fact be envisaged to inject a sequence of pulses each having a duration of about one microsecond for example. The duration of a pulse and/or the time lapse between two successive pulses can be modulated. Thus, the light signal obtained enables a piece of information, for example of Morse type, to be coded.

The shape of the chamber 1 can for example be tubular (FIG. 4), a hollow cylinder, an oval (FIGS. 1 to 3) or a swollen tube comprising the magnet 2 and/or the antenna 3 inside or outside the space filled with the gas. When the magnet 2 is located outside the space filled with the gas, it is however still substantially enveloped by the chamber 1, for example by placing the magnet 2 in an external housing, as represented in FIG. 2. An external housing can also be envisaged for other shapes of the chamber 1, for example for a tubular chamber. Another example is represented in FIG. 5, where the magnet 2 is arranged in the center of the chamber 1 which presents the form of a hollow cylinder. The assembly formed by the chamber 1 and the magnet 2 is preferably surrounded by a protective meshing 8 protecting against ultra high-frequency radiation.

Unlike Helmholz coils, the permanent magnet 2 can in particular be arranged in such a way that the chamber 1 envelops the magnet, whether the magnet 2 is arranged inside the chamber 1 (FIGS. 1 and 3) or outside the chamber 1 in an external housing (FIG. 2), while being enveloped by the chamber 1. A large solid angle can in this way be freed for the light L. Furthermore, when the chamber 1 comprises a fine protective meshing 8, the magnet 2 can then be located inside the meshing 8 (FIG. 2), whereas, as the meshing forms a resonance cage, Helmholz coils could not be arranged inside the meshing on account of the incompatibility of the coils and of the radiofrequency field. But the minimum dimensions of the resonance cage are determined by the resonance frequency. For example, for a resonance frequency of 2.45 GHz, the resonance cage must have minimum dimensions comprised between 6 cm and 10 cm. The use of a permanent magnet then enables the dimensions of the whole of the light source to be reduced to the dimensions of the resonance cage, whereas Helmholz coils would be added to the dimensions of the resonance cage.

Furthermore, Helmholz coils require additional electrical connections. The compactness of the light source is thereby improved, which is particularly necessary for the case of a portable light source or for integrating the source in other devices.

The invention is not limited to the particular embodiments represented in the figures. The fine protective meshing can cover the chamber and/or the assembly formed by the chamber and the antennas and possibly the magnets. Operation of the light source is independent from the geometric shape of the magnet and of the chamber.

1. Light source supplied by ultra high frequency, comprising an emitter which, by means of at least one antenna, creates an ultra high-frequency electromagnetic wave in a sealed chamber having a wall transparent to light and containing a gas at low pressure, the source comprising magnetic means designed to create a static magnetic field inside the chamber, the respective values of the static magnetic field and of the frequency of the electromagnetic wave being predetermined in such a way as to cause an electron cyclotron resonance inside the chamber, source wherein the magnetic means are formed by at least one permanent magnet substantially enveloped by the chamber and wherein the emitter, the antenna and the magnet are disposed with respect to the chamber in such a way as to free a solid angle of at least 2π steradians for the light.

2. Light source according to claim 1, wherein the antenna is arranged inside the chamber.

3. Light source according to claim 1, wherein the magnet constitutes the antenna.

4. Light source according to claim 1, wherein the magnet is arranged inside the chamber.

5. Light source according to claim 1, wherein the magnet is arranged outside the chamber.

6. Light source according to claim 5, wherein the chamber comprises an external housing for the magnet.

7. Light source according to claim 1, wherein the magnet and the antenna penetrate into the chamber in hermetically sealed manner.

8. Light source according to claim 1, wherein the chamber comprises a fluorescent coating transforming an ultraviolet radiation into a visible radiation.

9. Light source according to claim 1, wherein the chamber comprises a transparent conducting coating.

10. Light source according to claim 1, wherein the source comprises a fine protective meshing protecting against ultra high-frequency radiation.

11. Light source according to claim 1, wherein the chamber has a shape chosen from among tubular, hollow cylindrical and oval shapes.
